(19) United States
(12) Patent Application Publication
(10) Pub. No.: US 2015/0096934 A1
(43) Pub. Date: Apr. 9, 2015

(54) Preparation method of homogeneous-reinforced PVDF hollow fiber membrane

(71) Applicant: TIANJIN POLYTECHNIC UNIVERSITY, Tianjin (CN)

(72) Inventors: Changfa Xiao, Tianjin (CN); Xuliang Zhang, Tianjin (CN); Xiaoyu Hu, Tianjin (CN); Shulin An, Tianjin (CN); Qinglin Huang, Tianjin (CN); Guolan Huan, Tianjin (CN)

(21) Appl. No.: 14/381,213

(22) PCT Filed: Jan. 24, 2013
(86) PCT No.: PCT/CN2013/000074

§ 371 Date: Aug. 27, 2014

(30) Foreign Application Priority Data
Mar. 28, 2012 (CN) 201210085342.9

(51) Int. Cl. B01D 71/34; B01D 63/02; B01D 67/00; B01D 69/08; B01D 69/12

(52) U.S. Cl. CPC B01D 71/34; B01D 69/088; B01D 69/12; B01D 67/002; B01D 63/02; B01D 63/021; B01D 2323/00; B01D 2325/40
USPC 210/500.23; 427/244

(57) ABSTRACT

A preparation method of a homogeneous-reinforced PVDF hollow fiber membrane includes steps of: a) preparing a reinforced matrix membrane, wherein a PVDF hollow fiber membrane is utilized as the reinforced matrix membrane; b) preparing a PVDF casting solution, wherein mass fractions of the PVDF casting solution are: PVDF 6˜20 wt %; hydrophilic polymers or hydrophilic inorganic particles 0.6˜2 wt %; pore-forming agent 6˜10 wt %; and solvent 68˜87.4 wt %; mixing the above solutes in a water bath with a temperature of 70˜90° C., dissolving for 3˜4 h with stirring, then deaerating under vacuum for obtaining the uniform PVDF casting solution; and c) preparing the homogeneous-reinforced membrane; wherein the PVDF casting solution is uniformly coated on an outer surface of the reinforced matrix membrane through a spinning spinneret, then the reinforced matrix membrane is towed by a filament guide roller in such a manner that the hollow fiber forms a membrane, then the membrane passes through an air gap with a length of 5˜20 cm and is immersed in ultrafiltered water for coagulation, in such a manner that the homogeneous-reinforced membrane is obtained; wherein a traction speed is 5˜25 cm/(r·min).

### CROSS REFERENCE OF RELATED APPLICATION

This is a U.S. National Stage under 35 U.S.C 371 of the International Application PCT/CN2013/000074, filed Jan. 24, 2013, which claims priority under 35 U.S.C. 119(a-d) to CN 201210085342.9, filed Mar. 28, 2012.

### BACKGROUND OF THE PRESENT INVENTION

1. Field of Invention

The present invention relates to a preparation technology of hollow fiber membrane, and more particularly to a preparation method of homogeneous-reinforced PVDF (polyvinylidene fluoride) hollow fiber membrane.

2. Description of Related Arts

In the modern society which puts emphasis on environmental protection and sustainable development, membrane technology is combined with conventional activated sludge treatment technologies for forming a membrane bioreactor (MBR) technology, which is a key technology for reutilization of wasted water, and is one of the most promising high-tech in the 21st century.

Polyvinylidene fluoride (PVDF) is widely utilized because of advantages such as sufficient anti-pollution ability, mechanical properties, UV resistance, weathering resistance, chemical stability (wherein the PVDF is not easy to be corroded by acids, bases, strong oxidants and halogens, and is able to resist many conventional organic solvent), and the PVDF is recognized by many membrane producing companies. However, tensile strength of the conventional PVDF hollow fiber membrane prepared by immersion precipitation is low. Therefore, in practice, the hollow fiber membrane will be greatly damaged by long-time scour with high-pressure water, impact disturbance, and frequent cleaning. And broken hollow fiber has become a common phenomenon during application of hollow fiber membrane.

At present, researches of conventional reinforced hollow fiber membranes are mainly based on membrane material, preparation conditions, and preparation method. For example, thermally induced phase separation (TIPS) is able to effectively improve the mechanical properties of the obtained hollow fiber membrane, but filtration and permeability of the obtained membrane is not able to be considered at the same time, and embedded contamination will happen during practical applications. As a result, cleaning frequency and energy consumption are increased, and the service life of the membrane is directly decreased. According to the researches of conventional reinforced hollow fiber membrane, filament enhancement method is mostly utilized, wherein the hollow fibers are mainly reinforced by applying filament at different locations. Canada Zenon Company has developed a hollow fiber membrane technology with support (see U.S. Pat. No. 5,472,607), wherein a special continuous microfiber preparation tube is utilized, then casting solution is coated on the outer surface thereof, and coagulation is provided in the coagulation bath. U.S. Pat. No. 4,787,928 disclosed a method for applying a porous tubular enhancement layer on an external surface of a tubular membrane, wherein the outer enhancement layer is not connected to the inner tubular separating membrane, and the enhancement layer is mainly utilized for restricting an expansion effect of the membrane under a certain pressure. Li Pingli et al. prepared a fiber-reinforced PVDF membrane (see Chinese patent application CN 1695777 A), and then developed a mesh-fiber-reinforced PVDF hollow fiber membranes based on the fiber-reinforced PVDF membrane (see Chinese patent application CN 1864828 A), wherein a pore diameter of the obtained membrane is easier to control, and tensile strength is significantly improved. However, interfacial bonding strength of the above heterogeneously-reinforced hollow fiber membranes is poor. And in actual use, hollow fiber will be broken easily, and the coating layer and the enhancement layer will be stripped from each other. As a result, quality of the outlet water is severely decreased, and improvement of the service life of the membrane is severely restricted.

### SUMMARY OF THE PRESENT INVENTION

According to disadvantages of conventional technologies, an object of the present invention is to provide a preparation method of a homogeneous-reinforced PVDF hollow fiber membrane, wherein the preparation method is simple and is easy to be industrialized. Furthermore, because hydrophilic materials are utilized in a coating layer of the hollow fiber membrane obtained, not only mechanical properties thereof are improved, but also hydrophilic properties are improved.

Accordingly, in order to accomplish the above objects, the present invention provides a preparation method of a homogeneous-reinforced PVDF hollow fiber membrane, comprising steps of:

a) preparing a reinforced matrix membrane, wherein a PVDF hollow fiber membrane with a pore diameter of 0.2˜5 μm is prepared by a melting spinning and stretching method, and the obtained PVDF hollow fiber membrane is utilized as the reinforced matrix membrane of the homogeneous-reinforced PVDF hollow fiber membrane;

b) preparing a PVDF casting solution, wherein mass fractions of the PVDF casting solution are:

| | | |
|---|---|---|
| PVDF | 6~20 | wt % |
| Hydrophilic polymers or | 0.6~2 | wt % |
| hydrophilic inorganic particles | | |
| Pore-forming agent | 6~10 | wt % |
| Solvent | 68~87.4 | wt % |

mixing the above solutes in a water bath with a temperature of 70˜90° C., dissolving for 3˜4 h with stirring, then deaerating under vacuum for obtaining the uniform PVDF casting solution, wherein the hydrophilic polymer is polyacrylonitrile or polyvinyl alcohol; the hydrophilic inorganic particle is hydrophilic silicon dioxide; the pore-forming agent is polyvinylpyrrolidone, polyethylene glycol or Tween-80; the solvent is dimethylformamide, dimethylacetamide or dimethyl sulfoxide; and

c) preparing the homogeneous-reinforced PVDF hollow fiber membrane; wherein the PVDF casting solution is uniformly coated on an outer surface of the reinforced matrix membrane through a spinning spinneret, the reinforced matrix membrane is towed by a filament guide roller in such a manner that the hollow fiber is squeezed out for forming a membrane, then the membrane passes through an air gap with a length of 5˜20 cm and is immersed in an ultrafiltered water coagulation bath for coagulation, in such a manner that the homogeneous-reinforced PVDF hollow fiber membrane is obtained; wherein a traction speed is 5˜25 cm/(r·min)

Compared to the conventional technology, the preparation method according to the present invention has advantages as follows. Sufficient thermodynamic compatibility of homogeneous materials is taken full advantage of, wherein with a homogeneous-reinforced technology, the PVDF casting solution is uniformly coated on the outer surface of the PVDF hollow fiber membrane obtained by melt spinning and stretching; a membrane is formed by a phase inversion method in the coagulation bath with a certain traction speed; and compared to heterogeneously-reinforced membranes, interfacial bonding strength is improved. Furthermore, the hydrophilic PVDF casting solution prepared by mixing the hydrophilic components with the PVDF forms a membrane with the same method. The homogeneous-reinforced PVDF hollow fiber membrane obtained has advantages of the membrane prepared by the melt spinning and stretching method and the membrane prepared by the solution spinning method. Not only hydrophilic properties are improved, but also mechanical properties are improved.

These and other objectives, features, and advantages of the present invention will become apparent from the following detailed description, the accompanying drawings, and the appended claims.

### BRIEF DESCRIPTION OF THE DRAWINGS

FIG. 1 is a SEM photograph of a homogeneous-reinforced PVDF hollow fiber membrane prepared by a preparation method according to a preferred embodiment of the present invention.

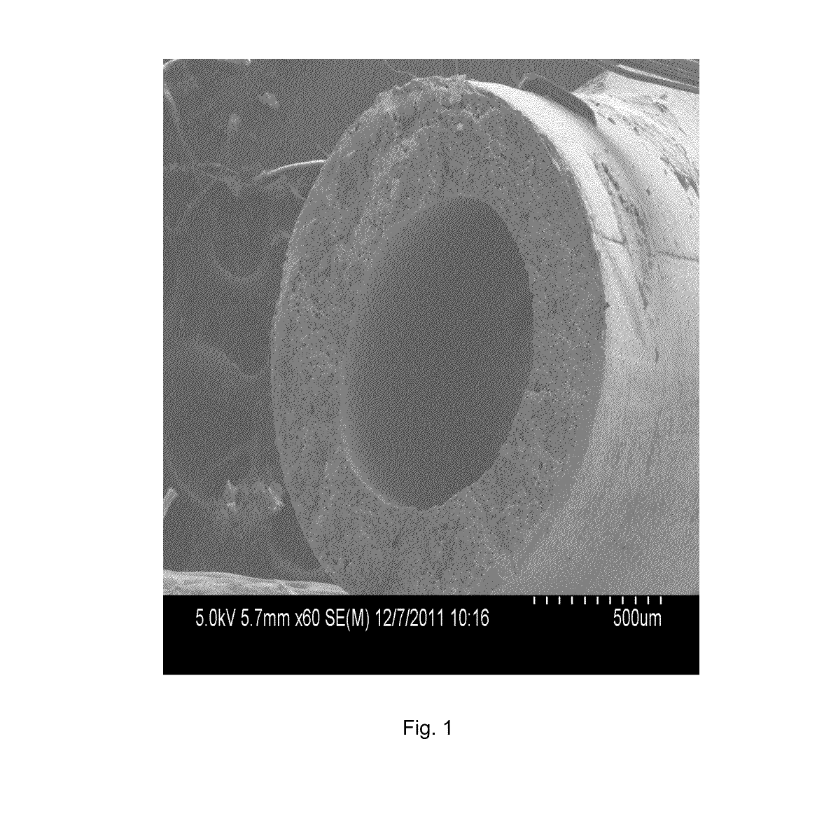

FIG. 2 is an enlarged cross-section SEM photograph of the homogeneous-reinforced PVDF hollow fiber membrane prepared by the preparation method according to the preferred embodiment of the present invention.

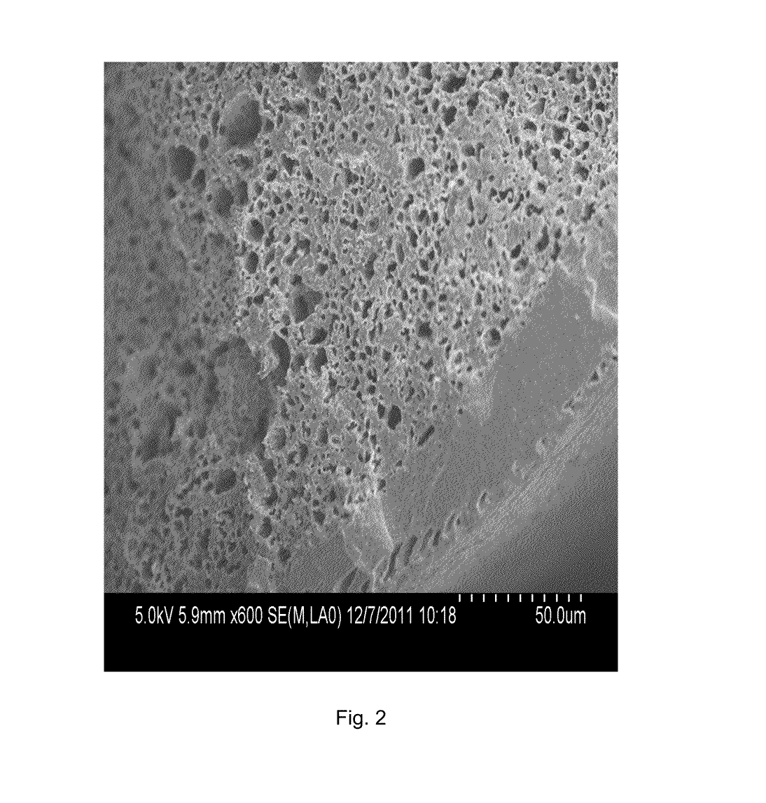

### DETAILED DESCRIPTION OF THE PREFERRED EMBODIMENT

Referring to the drawings, a preparation method of a homogeneous-reinforced PVDF hollow fiber membrane according to a preferred embodiment of the present invention is illustrated, comprising steps of:

a) preparing a reinforced matrix membrane, wherein a PVDF hollow fiber membrane is prepared by melt spinning and stretching process, and the PVDF hollow fiber membrane is utilized as the reinforced matrix membrane of the homogeneous-reinforced PVDF hollow fiber membrane, wherein a pore diameter is 0.2˜5 μm;

b) preparing a PVDF casting solution, wherein mass fractions of the PVDF casting solution are:

| | | |
|---|---|---|
| PVDF | 6~20 | wt % |
| Hydrophilic polymers or | 0.6~2 | wt % |
| hydrophilic inorganic particles | | |
| Pore-forming agent | 6~10 | wt % |
| Solvent | 68~87.4 | wt % |

mixing the above solutes in a water bath with a temperature of 70˜90° C., dissolving for 3˜4 h with stirring, then deaerating under vacuum for obtaining the uniform PVDF casting solution, wherein the hydrophilic polymer is polyacrylonitrile (PAN) or polyvinyl alcohol (PVA); the hydrophilic inorganic particle is hydrophilic silicon dioxide (SiO₂); the pore-forming agent is polyvinylpyrrolidone (for example, PVP K30), polyethylene glycol (for example, PEG600) or Tween-80; the solvent is dimethylformamide, dimethylacetamide or dimethyl sulfoxide; although the mass fraction of the hydrophilic polymers or the hydrophilic inorganic particles is 0.6˜2 wt %, a mass fraction lower than 0.6 wt % or higher than 2 wt % may also be applicable; and

c) preparing the homogeneous membrane; wherein the PVDF casting solution is uniformly coated on an outer surface of the reinforced matrix membrane through a spinning spinneret, the reinforced matrix membrane is towed by a filament guide roller in such a manner that the hollow fiber is squeezed out for forming a membrane, then the membrane passes through an air gap with a length of 5˜20 cm and is immersed in an ultrafiltered water coagulation bath for coagulation, in such a manner that the homogeneous membrane is obtained; wherein a traction speed is 5˜25 cm/(r·min), a temperature of the coagulation bath is room temperature or raised to 30˜50° C.

Because PVDF based membrane in the solvent will swell and dissolve, an infiltration time in the casting solution must be effectively controlled. On one hand, if the infiltration time is too long, the PVDF base membrane will be badly dissolved, and mechanical properties of the enhancement membrane will be greatly reduced. On the other hand, if the infiltration time is too short, the casting solution will not provide a sufficient infiltration effect on the base membrane, and interfacial bonding strength will not be high. As a result, overall performance of the enhancement membrane is decreased. Therefore, the air gap together with the traction speed determines the infiltration time or a staying time of the base membrane in the casting solution, i.e., determines a dissolution extent. Preferably, the air gap is 5˜20 cm long, the traction speed is 5˜25 cm/(r·min) Under such a condition, the overall performance of the homogeneous-reinforced membrane is better.

The homogeneous-reinforced PVDF hollow fiber membrane is able to be prepared by the preparation method according to the preferred present. The homogeneous-reinforced membrane has advantages of a membrane prepared by a melt spinning and stretching method and solution and stretching spinning method. Not only hydrophilic properties are improved, but also mechanical properties are improved.

Those not described in the present invention are applicable to the conventional technologies.

The following is preferred embodiments of the present invention, which are exemplary only and not intended to be limiting.

### PREFERRED EMBODIMENT 1

Preparation of a base membrane: preparing a PVDF hollow fiber membrane by the melt spinning and stretching method, and utilizing the PVDF hollow fiber membrane as a reinforced matrix membrane, wherein a maximum pore diameter is 1.4 μm.

Preparation of a casting solution: mixing PVDF with a mass fraction of 14 wt % with PVP K30 with a mass fraction of 10 wt %, then dissolving in dimethylacetamide with a mass fraction of 76 wt %, fully dissolving at 70° C. with stirring, then deaerating in a vacuum oven at 70° C. for obtaining a clear casting solution.

Preparation of a homogeneous membrane: uniformly coating the PVDF casting solution on an outer surface of the reinforced matrix membrane through a spinning spinneret, forming a membrane by towing the reinforced matrix membrane with a filament guide roller, wherein a traction speed is 10 cm/(r·min), then immersing the membrane in an ultrafiltered water coagulation bath at a room temperature after passing through an air gap with a length of 15 cm, waiting for 24 h before the membrane is coagulated and forms a homogeneous-reinforced membrane.

Performance test: a pure water flux of the homogeneous-reinforced PVDF membrane is 162.3 L·m⁻²·h⁻¹0.1 MPa; breaking strength is 8.6 MPa; a maximum pore diameter is 0.5 μm; after continuous recoil under a pressure of 0.1 MPa for 8 h, the inner surface does not separate from the outer layer.

### PREFERRED EMBODIMENT 2

Preparation of a base membrane: preparing a PVDF hollow fiber membrane by the melt spinning and stretching method, and utilizing the PVDF hollow fiber membrane as a reinforced matrix membrane, wherein a maximum pore diameter is 2.2 μm.

Preparation of a casting solution: mixing PVDF with a mass fraction of 18 wt % with a pore-forming agent with a mass fraction of 8 wt % (wherein a mass fraction of PEG 600 is 5 wt %, a mass fraction of Tween-80 is 3 wt %), then dissolving in dimethylacetamide with a mass fraction of 74 wt %, fully dissolving at 70° C. with stirring, then deaerating in a vacuum oven at 70° C. for obtaining a clear casting solution.

Preparation of a homogeneous membrane: uniformly coating the PVDF casting solution on the outer surface of the reinforced matrix membrane through a spinning spinneret, forming a membrane by towing the reinforced matrix membrane with a filament guide roller, wherein a traction speed is 25 cm/(r·min), then immersing the membrane in an ultrafiltered water coagulation bath at 40° C. after passing through an air gap with a length of 5 cm, waiting for 24 h before the membrane is coagulated and forms a homogeneous-reinforced membrane.

Performance test: a pure water flux of the homogeneous-reinforced PVDF membrane is 102.7 L·m⁻²·h⁻¹0.1 MPa; breaking strength is 9.8 MPa; a maximum pore diameter is 0.4 μm; after continuous recoil under a pressure of 0.1 MPa for 8 h, the inner surface does not separate from the outer layer.

### PREFERRED EMBODIMENT 3

Preparation of a base membrane: preparing a PVDF hollow fiber membrane by the melt spinning and stretching method, and utilizing the PVDF hollow fiber membrane as a reinforced matrix membrane, wherein a maximum pore diameter is 0.9 μm.

Preparation of a casting solution: mixing PVDF with a mass fraction of 10 wt % (wherein a mass fraction of the PVDF is 9 wt %, a mass fraction of SiO₂ is 1 wt %) with a pore-forming agent with a mass fraction of 6 wt % (wherein a mass fraction of PVP K30 is 4.2 wt %, a mass fraction of Tween-80 is 1.8 wt %), then dissolving in dimethylacetamide with a mass fraction of 84 wt %, fully dissolving at 70° C. with stirring, then deaerating in a vacuum oven at 70° C. for obtaining a clear casting solution.

Preparation of a homogeneous membrane: uniformly coating the PVDF casting solution on an outer surface of the reinforced matrix membrane through a spinning spinneret, forming a membrane by towing the reinforced matrix membrane with a filament guide roller, wherein a traction speed is 15 cm/(r·min), then immersing the membrane in an ultrafiltered water coagulation bath at a room temperature after passing through an air gap with a length of 20 cm, waiting for 24 h before the membrane is coagulated and forms a homogeneous-reinforced membrane.

Performance test: a pure water flux of the homogeneous-reinforced PVDF membrane is 287.6 L·m⁻²·h⁻¹0.1 MPa; breaking strength is 9.85 MPa; a maximum pore diameter is 0.49 μm; after continuous recoil under a pressure of 0.1 MPa for 8 h, the inner surface does not separate from the outer layer.

### PREFERRED EMBODIMENT 4

Preparation of a base membrane: preparing a PVDF hollow fiber membrane by the melt spinning and stretching method, and utilizing the PVDF hollow fiber membrane as a reinforced matrix membrane, wherein a maximum pore diameter is 1.0 μm.

Preparation of a casting solution: mixing PVDF/PAN with a mass fraction of 10 wt % (wherein a mass fraction of the PVDF is 9 wt %, a mass fraction of PAN is 1 wt %) with a pore-forming agent with a mass fraction of 10 wt % (wherein a mass fraction of PVP K30 is 8.2 wt %, a mass fraction of Tween-80 is 1.8 wt %), then dissolving in dimethylacetamide with a mass fraction of 80 wt %, fully dissolving at 70° C. with stirring, then deaerating in a vacuum oven at 70° C. for obtaining a clear casting solution.

Preparation of a homogeneous membrane: uniformly coating the PVDF casting solution on an outer surface of the reinforced matrix membrane through a spinning spinneret, forming a membrane by towing the reinforced matrix membrane with a filament guide roller, wherein a traction speed is 15 cm/(r·min), then immersing the membrane in an ultrafiltered water coagulation bath at a room temperature after passing through an air gap with a length of 10 cm, waiting for 24 h before the membrane is coagulated and forms a homogeneous-reinforced membrane.

Performance test: a pure water flux of the homogeneous-reinforced PVDF membrane is 426.4 L·m⁻²·h⁻¹0.1 MPa; breaking strength is 10.5 MPa; a maximum pore diameter is 0.55 μm; after continuous recoil under a pressure of 0.1 MPa for 8 h, the inner surface does not separate from the outer layer.

### PREFERRED EMBODIMENT 5

Preparation of a base membrane: preparing a PVDF hollow fiber membrane by the melt spinning method, and utilizing the PVDF hollow fiber membrane as an reinforced matrix membrane, wherein a maximum pore diameter is 1.2 μm.

Preparation of a casting solution: mixing PVDF/PVA with a mass fraction of 10 wt % (wherein a mass fraction of the PVDF is 9 wt %, a mass fraction of PVA is 1 wt %) with a pore-forming agent with a mass fraction of 10 wt % (wherein a mass fraction of PVP K30 is 8 wt %, a mass fraction of Tween-80 is 2 wt %), then dissolving in dimethylacetamide with a mass fraction of 80 wt %, fully dissolving at 90° C. with stirring, then deaerating in a vacuum oven at 90° C. for obtaining a clear casting solution.

Preparation of a homogeneous membrane: uniformly coating the PVDF casting solution on the outer surface of the reinforced matrix membrane through a spinning spinneret, forming a membrane by towing the reinforced matrix membrane with a filament guide roller, wherein a traction speed is 20 cm/(r·min), then immersing the membrane in an ultrafiltered water coagulation bath at 50° C. after passing through an air gap with a length of 10 cm, waiting for 24 h before the membrane is coagulated and forms a homogeneous-reinforced membrane.

Performance test: a pure water flux of the homogeneous-reinforced PVDF membrane is 187.2 L·m⁻²·h⁻¹0.1 MPa; breaking strength is 10.3 MPa; a maximum pore diameter is 0.46 μm; after continuous recoil under a pressure of 0.1 MPa for 8 h, the inner surface does not separate from the outer layer.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A preparation method of a homogeneous-reinforced PVDF hollow fiber membrane, comprising steps of:
a) preparing a reinforced matrix membrane, wherein a PVDF (polyvinylidene fluoride) hollow fiber membrane with a pore diameter of 0.2˜5 μm is prepared by melt spinning and stretching process, and the PVDF hollow fiber membrane is utilized as the reinforced matrix membrane of the homogeneous-reinforced PVDF hollow fiber membrane;
b) preparing a PVDF casting solution, wherein mass fractions of the PVDF casting solution are:

| | | |
|---|---|---|
| PVDF | 6~20 | wt % |
| Hydrophilic polymers or | 0.6~2 | wt % |
| hydrophilic inorganic particles | | |
| Pore-forming agent | 6~10 | wt % |
| Solvent | 68~87.4 | wt % |

mixing the above solutes in a water bath with a temperature of 70˜90° C., dissolving for 3˜4 h with stirring, then deaerating under vacuum for obtaining the uniform PVDF casting solution, wherein the hydrophilic polymer is polyacrylonitrile or polyvinyl alcohol; the hydrophilic inorganic particle is hydrophilic silicon dioxide; the pore-forming agent is polyvinylpyrrolidone, polyethylene glycol or Tween-80; the solvent is dimethylformamide, dimethylacetamide or dimethyl sulfoxide; and
c) preparing the homogeneous-reinforced PVDF hollow fiber membrane; wherein the PVDF casting solution is uniformly coated on an outer surface of the reinforced matrix membrane through a spinning spinneret, the reinforced matrix membrane is towed by a filament guide roller in such a manner that the hollow fiber is squeezed out for forming a membrane, then the membrane passes through an air gap with a length of 5˜20 cm and is immersed in an ultrafiltered water coagulation bath for coagulation, in such a manner that the homogeneous-reinforced PVDF hollow fiber membrane is obtained; wherein a traction speed is 5˜25 cm/(r·min)

2. A homogeneous-reinforced PVDF hollow fiber membrane, wherein the homogeneous-reinforced PVDF hollow fiber membrane is prepared by the preparation method as recited in claim 1.
